(19) United States
(12) Patent Application Publication
(10) Pub. No.: US 2021/0277718 A1
(43) Pub. Date: Sep. 9, 2021

(54) Ladder Support Hook Apparatus

(71) Applicant: De Roin Kent, White Cloud, KS (US)

(72) Inventor: De Roin Kent, White Cloud, KS (US)

(21) Appl. No.: 16/807,931

(22) Filed: Mar. 3, 2020

(51) Int. Cl. E06C 7/50; E06C 7/46; E06C 7/48; E06C 7/06

(52) U.S. Cl. CPC E06C 7/505; E06C 7/06; E06C 7/48; E06C 7/46

(57) ABSTRACT

A ladder support hook apparatus for securing a ladder in place includes a base foot having a base top side and a base bottom side. The base top side has a plurality of mounting apertures extending through the base bottom side. An extendable arm is coupled to the base foot. The arm comprises a lower portion pivotably coupled to the base top side and an upper portion adjustably coupled to the lower portion. An engagement hook is coupled to the extendable arm. The engagement hook has a flat portion pivotably coupled to the upper portion and a hooked portion extending from the flat portion. The hooked portion is configured to selectively engage a rung of a ladder.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ladder safety devices and more particularly pertains to a new ladder safety device for securing a ladder in place.

### (2) Description of Related Art including Information Disclosed Under 37 CFR 1.97 and 1.98.

The prior art relates to ladder safety devices.

### BRIEF SUMMARY OF THE INVENTION

An embodiment of the disclosure meets the needs presented above by generally comprising a base foot having a base top side and a base bottom side. The base top side has a plurality of mounting apertures extending through the base bottom side. An extendable arm is coupled to the base foot. The arm comprises a lower portion pivotably coupled to the base top side and an upper portion adjustably coupled to the lower portion. An engagement hook is coupled to the extendable arm. The engagement hook has a flat portion pivotably coupled to the upper portion and a hooked portion extending from the flat portion. The hooked portion is configured to selectively engage a rung of a ladder.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a ladder support hook apparatus according to an embodiment of the disclosure.

FIG. 2 is an isometric view of an embodiment of the disclosure.

FIG. 3 is a detail isometric view of an embodiment of the disclosure.

FIG. 4 is a cross-sectional view of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

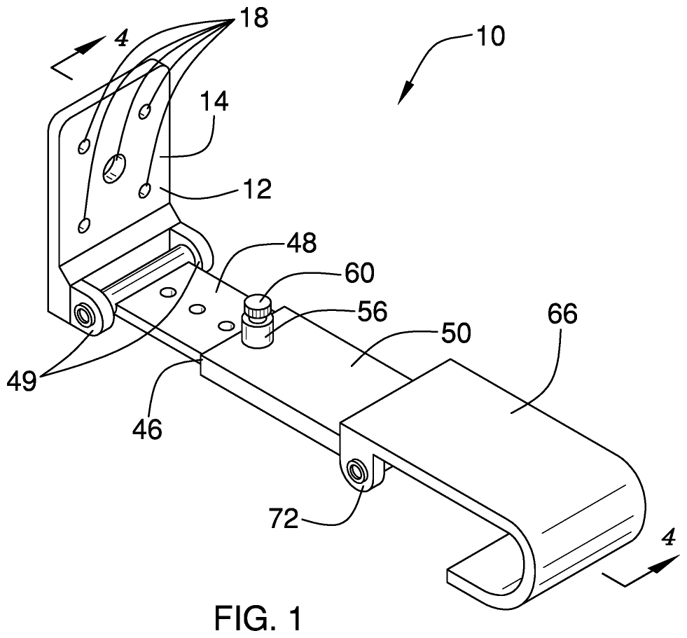

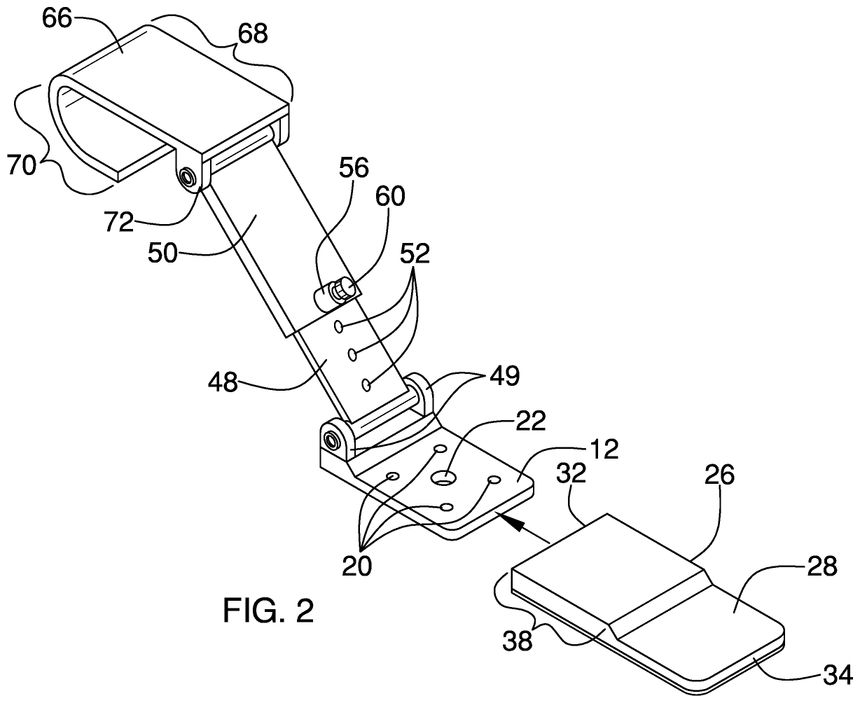

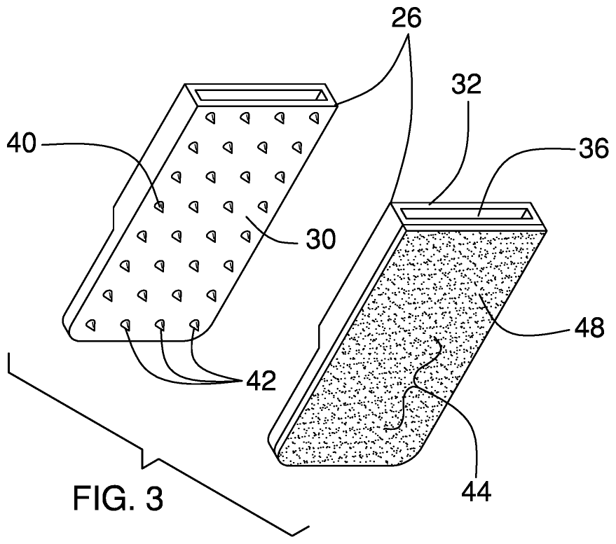

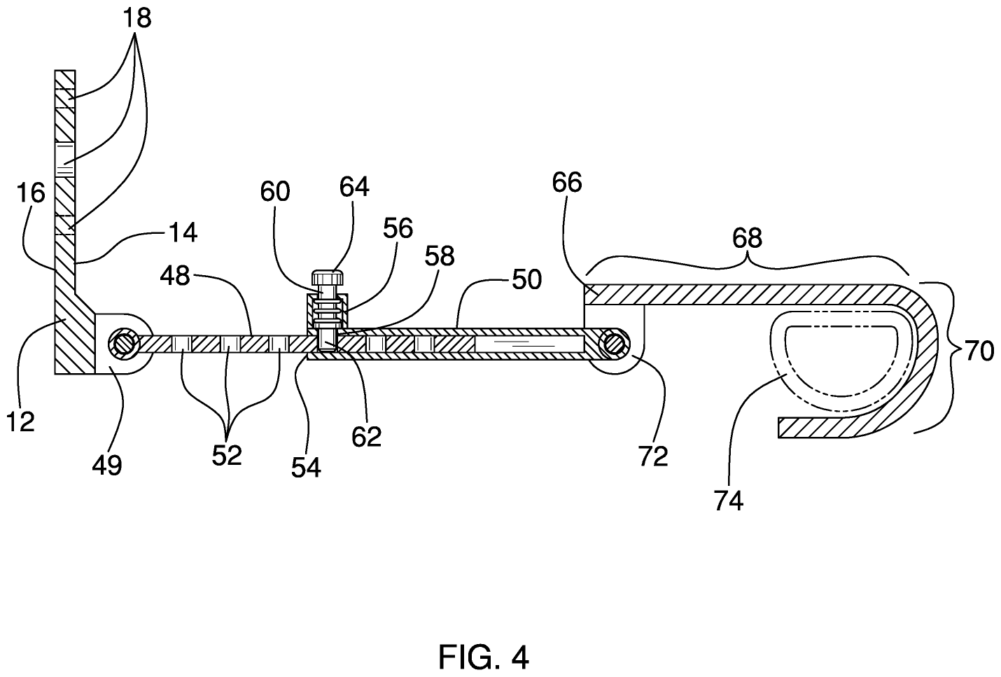

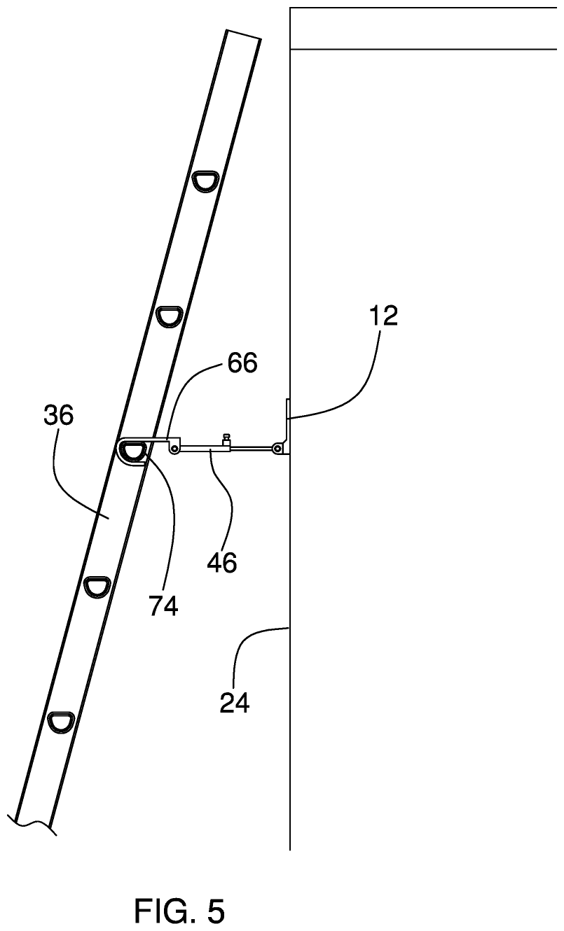

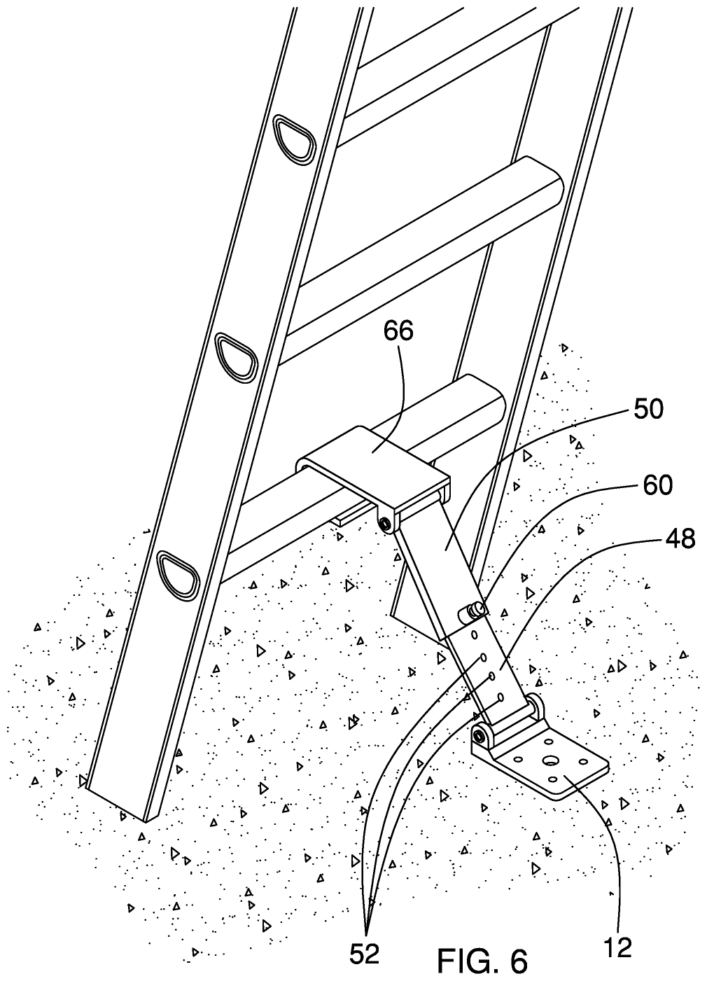

With reference now to the drawings, and in particular to FIGS. 1 through 6 thereof, a new ladder safety device embodying the principles and concepts of an embodiment of the disclosure and generally designated by the reference numeral 10 will be described.

As best illustrated in FIGS. 1 through 6, the ladder support hook apparatus 10 generally comprises a base foot 12 having a base top side 14 and a base bottom side 16. The base top side 14 has a plurality of mounting apertures 18 extending through the base bottom side 16. The plurality of mounting apertures 18 may comprise a set of four corner apertures 20 and a central aperture 22. The central aperture 22 is larger than each of the corner apertures 20. The mounting apertures 18 are configured to receive mounting hardware to fix the base foot 12 to either the ground or to a wall 24.

There may be at least one foot cover 26 to be used rather than mounting hardware. Each foot cover 26 has a cover top side 28, a cover bottom side 30, a cover front end 32, and a cover back end 34. The cover front end 32 has a foot slot 36 extending towards the cover back end 34. The cover top side 28 may have a raised portion 38 adjacent the cover front end 32. The foot slot 36 extends within the raised portion 38 and is configured to receive the base foot 12. The cover bottom side 30 has a plurality of grips 40 extending therefrom to prevent slippage. The plurality of grips 40 may be one of a plurality of evenly spaced spikes 42, a plurality of continuous texture granules 44, or the like. Depending on the surface on which the foot cover 26 is being used the appropriate grips 40 may be selected.

An extendable arm 46 is coupled to the base foot 12. The arm 46 comprises a lower portion 48 pivotably coupled to a pair of base ears 49 of the base top side 14 and an upper portion 50 adjustably coupled to the lower portion 48. The lower portion 48 has an array of adjustment apertures 52 extending therethrough. The upper portion 50 is hollow and has an open bottom end 54 to slidingly receive the lower portion 48. The upper portion 50 has a pin housing 56 extending around a pin aperture 58 and a spring-loaded pin 60 coupled within the pin housing 56. The pin 60 has a shaft 62 and a pinhead 64. The pinhead 64 may be textured for improved grip. The shaft 62 selectively extends through the pin aperture 58 to engage one of the array of adjustment apertures 52 and secure the lower portion 48 in place.

An engagement hook 66 is coupled to the extendable arm 46. The engagement hook 66 has a flat portion 68 pivotably coupled to the upper portion 50 and a hooked portion 70 extending from the flat portion 68. The flat portion 68 has a pair of hook ears 72 coupled to the upper portion 50. The hooked portion 70 is configured to selectively engage a rung 74 of a ladder 76.

In use, the base foot 12 is secure to the ground or the wall 24, or the foot cover 26 is slid on to the base foot 12. The extendable arm 46 is then adjusted to the desired length and the hooked portion 70 of the engagement hook 66 is engaged with the rung 74 of the ladder to prevent the ladder 76 from slipping.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ladder support hook apparatus comprising:
a base foot, the base foot having a base top side and a base bottom side, the base top side having a plurality of mounting apertures extending through the base bottom side;
an extendable arm coupled to the base foot, the arm comprising a lower portion pivotably coupled to the base top side and an upper portion adjustably coupled to the lower portion; and
an engagement hook coupled to the extendable arm, the engagement hook having a flat portion pivotably coupled to the upper portion and a hooked portion extending from the flat portion, the hooked portion being configured to selectively engage a rung of a ladder.

2. The ladder support hook apparatus of claim 1 further comprising at least one foot cover, the foot cover having a cover top side, a cover bottom side, a cover front end, and a cover back end, the cover front end having a foot slot extending towards the cover back end, the foot slot being configured to receive the base foot, the cover bottom side having a plurality of grips extending therefrom.

3. The ladder support hook apparatus of claim 2 further comprising the plurality of grips being one of a plurality of evenly spaced spikes, a plurality of continuous texture granules, or the like.

4. The ladder support hook apparatus of claim 2 further comprising the cover top side having a raised portion adjacent the cover front end, the foot slot extending within the raised portion.

5. The ladder support hook apparatus of claim 1 further comprising the base top side having a pair of base ears, the extendable arm being coupled to the base ears; the flat portion of the engagement hook having a pair of hook ears coupled to the upper portion.

6. The ladder support hook apparatus of claim 1 further comprising the plurality of mounting apertures comprising a set of four corner apertures and a central aperture.

7. The ladder support hook apparatus of claim 6 further comprising the central aperture being larger than each of the corner apertures.

8. The ladder support hook apparatus of claim 1 further comprising the lower portion having an array of adjustment apertures extending therethrough, the upper portion being hollow and having an open bottom end to slidingly receive the lower portion, the upper portion having a pin housing extending around a pin aperture and a spring-loaded pin coupled within the pin housing, the pin having a shaft and a pinhead, the shaft selectively extending through the pin aperture to engage one of the array of adjustment apertures.

9. A ladder support hook apparatus comprising:
a base foot, the base foot having a base top side and a base bottom side, the base top side having a plurality of mounting apertures extending through the base bottom side, the plurality of mounting apertures comprising a set of four corner apertures and a central aperture, the central aperture being larger than each of the corner apertures;
at least one foot cover, the foot cover having a cover top side, a cover bottom side, a cover front end, and a cover back end, the cover front end having a foot slot extending towards the cover back end, the cover top side having a raised portion adjacent the cover front end, the foot slot extending within the raised portion and being configured to receive the base foot, the cover bottom side having a plurality of grips extending therefrom, the plurality of grips being one of a plurality of evenly spaced spikes, a plurality of continuous texture granules, or the like;
an extendable arm coupled to the base foot, the arm comprising a lower portion pivotably coupled to a pair of base ears of the base top side and an upper portion adjustably coupled to the lower portion, the lower portion having an array of adjustment apertures extending therethrough, the upper portion being hollow and having an open bottom end to slidingly receive the lower portion, the upper portion having a pin housing extending around a pin aperture and a spring-loaded pin coupled within the pin housing, the pin having a shaft and a pinhead, the shaft selectively extending through the pin aperture to engage one of the array of adjustment apertures; and
an engagement hook coupled to the extendable arm, the engagement hook having a flat portion pivotably coupled to the upper portion and a hooked portion extending from the flat portion, the flat portion having a pair of hook ears coupled to the upper portion, the hooked portion being configured to selectively engage a rung of a ladder.
